(19) United States
(12) Patent Application Publication
(10) Pub. No.: US 2016/0134354 A1
(43) Pub. Date: May 12, 2016

(54) COMMUNICATIONS DEVICE HAVING MULTIPLE ANTENNAS, AND METHOD OF OPERATING COMMUNICATIONS DEVICE

(71) Applicant: Samsung Electro-Mechanics Co., Ltd., Suwon-si (KR)

(72) Inventors: Seong Yeon KIM, Suwon-si (KR); Hong In KIM, Suwon-si (KR)

(73) Assignee: SAMSUNG ELECTRO-MECHANICS CO., LTD., Suwon-si (KR)

(21) Appl. No.: 14/933,424

(22) Filed: Nov. 5, 2015

(30) Foreign Application Priority Data
Nov. 10, 2014 (KR) 10-2014-0155484

(51) Int. Cl. H04B 7/08; H04W 4/00

(52) U.S. Cl. CPC H04B 7/08; H04W 4/008; H04W 88/06

(57) ABSTRACT

A communications device includes: antennas; and a communications controller configured to control each of the antennas to have a plurality of transmission and reception intervals, respectively, and to transmit or receive a plurality of signals according to the transmission or reception intervals.

### CROSS-REFERENCE TO RELATED APPLICATION(S)

This application claims the benefit of Korean Patent Application No. 10-2014-0155484 filed on Nov. 10, 2014 in the Korean Intellectual Property Office, the entire disclosure of which is incorporated herein by reference for all purposes.

### BACKGROUND

1. Field

The following description relates to a communications device having multiple antennas.

2. Description of Related Art

In accordance with consumer demand, attempts at creating a single communications device able to undertake communications using a plurality of network technologies have recently been undertaken.

Particularly, there has been demand for a single communications device enabling communications using different communications standards in the same frequency band.

For example, both Bluetooth and Wireless LAN (WLAN) standards use portions of the 2.4 GHz industrial, scientific, and medical (ISM) band.

In this case, the Bluetooth standard and the WLAN standard use frequencies within the same high frequency band, but since the WLAN system is operated using a larger amount of power than the Bluetooth system, the WLAN system may cover longer distances.

As such, in a case in which a plurality of network systems performing communications in the same frequency band are provided in the single communications device, mutual interference may occur between the plurality of systems and there is also a possibility that clashes between systems may occur.

Therefore, the development of a communications device capable of solving the above-mentioned problems is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a communications device includes: antennas; and a communications controller configured to control each of the antennas to have a plurality of transmission and reception intervals, and to transmit and receive a plurality of signals according to the transmission and reception intervals.

The communications controller may be configured to control the antennas to transmit and receive different signals in adjacent transmission or reception intervals.

The communications controller may be configured to control the antennas to transmit or receive different signals in transmission or reception intervals corresponding to each other.

The antennas may include a first antenna and a second antenna. The plurality of signals may include a first signal and a second signal. Each of the first antenna and the second antenna may alternately transmit or receive the first signal and the second signal in the plurality of transmission or reception intervals.

The first antenna may initially transmit or receive the first signal, and the second antenna may initially transmit or receive the second signal.

The communications device may further include a signal processor configured to convert the plurality of signals.

The signal processor may include a plurality of signal processors corresponding in number to the antennas.

The signal processor may include: a Bluetooth signal processor configured to convert a signal, among the plurality of signals, according to a Bluetooth communications standard; and a wireless LAN (WLAN) signal processor configured to convert another signal, among the plurality of signals, according to a WLAN communications standard.

The communications device may further include a channel information processor configured to process channel information of the antennas.

The channel information processor may be configured to process the channel information from preamble signals or pilot signals received by the antennas.

The channel information may include at least one of quality of service (QoS), noise, interference, loss, fading, or correlation.

The communications controller may include: a signal modulator configured to modulate the plurality of signals on the basis of the channel information; and an antenna controller configured to control the antennas to transmit and receive the plurality of signals modulated by the signal modulator which are divided according to the transmission or reception intervals.

The antenna controller may be configured to control the antennas to transmit or receive different signals in adjacent transmission or reception intervals.

The antenna controller may be configured to control the antennas to transmit or receive different signals in transmission or reception intervals corresponding to each other.

The communications controller may be configured to control a copy of the plurality of signals and may be configured to allow the copied signals to be repeatedly transmitted.

According to another general aspect, a method of operating a communications device includes: controlling, by a communications controller, at a first transmission or reception interval, a first antenna to transmit or receive a signal of a first communications standard; controlling, by the communications controller, at the first transmission or reception interval, the second antenna to transmit or receive a signal of a second communications standard; controlling, by the communications controller, at a second transmission or reception interval, the first antenna to transmit or receive the signal of the second communications standard; and controlling, by the communications controller, at the second transmission or reception interval, the second antenna to transmit or receive the signal of the first communications standard.

The method may further include: controlling, by the communications controller, at a third transmission or reception interval, the first antenna to transmit or receive the signal of the first communications standard; and controlling, by the communications controller, at the third transmission or reception interval, the second antenna to transmit or receive the signal of the second communications standard.

The first communications standard may be one of Bluetooth and WLAN, and the second communications standard may be the other of Bluetooth and WLAN.

Other features and aspects will be apparent from the following detailed description, the drawings, and the claims.

### BRIEF DESCRIPTION OF THE DRAWINGS

FIG. 1 is a diagram illustrating a communications device having multiple antennas according to an example.

FIG. 2 is a diagram illustrating a signal processor according to an example.

FIG. 3 is a diagram illustrating a communications controller according to an example.

FIG. 4 is a diagram illustrating signals transmitted through a communications device having multiple antennas according to an example.

FIG. 5 illustrates an example method of operating the communications device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

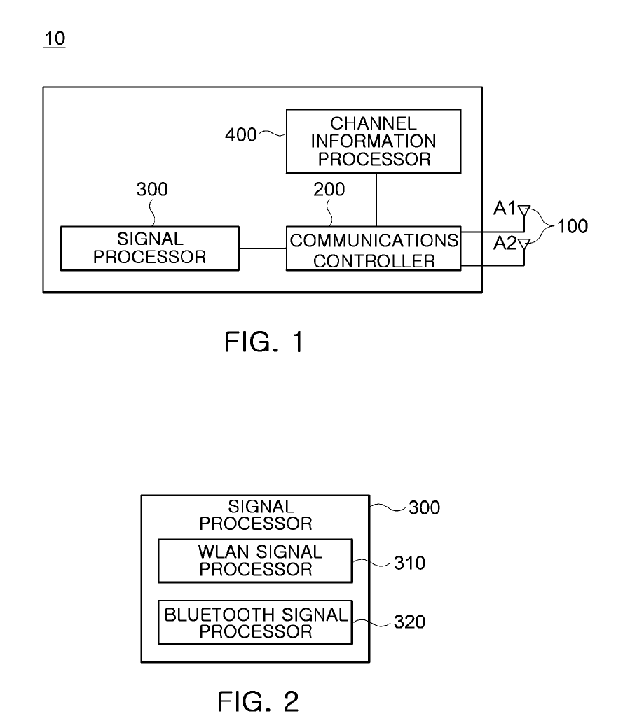

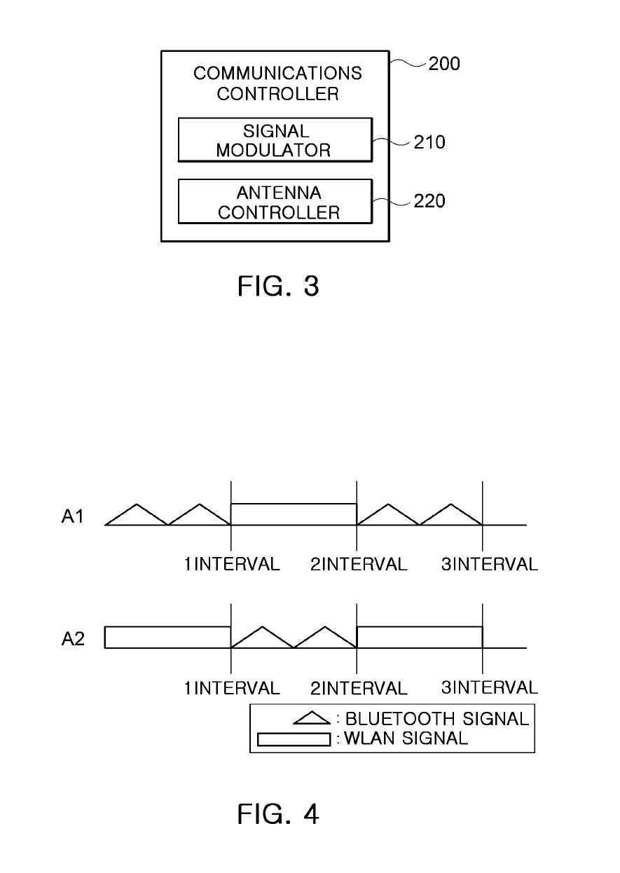

FIG. 1 is a diagram illustrating a communications device having multiple antennas according to an example. FIG. 2 is a diagram illustrating a signal processor according to an example. FIG. 3 is a diagram illustrating a communications controller according to an example.

As illustrated in FIG. 1, a communications device 10 having multiple antennas includes a plurality of wireless network systems provided therein. Particularly, the communications device 10 may be any device in which Bluetooth and WLAN systems using the same frequency band are provided to transmit and receive both Bluetooth and WLAN signals.

For example, the communications device 10 may be a smartphone, a portable gaming device, a wearable device, a tablet PC, or the like, in which Bluetooth and WLAN systems are integrated. However, the communications device 10 is not limited thereto. For example, any wireless network system may also be used, as long as a plurality of wireless network systems using the same frequency band can be provided in a single communications device.

The communications device 10 includes an antenna system 100 and a communications controller 200.

The antenna system 100, which includes components configured to transmit and receive signals wirelessly, may receive a signal from an external device or transmit a signal externally.

The antenna system 100 includes a plurality of antennas, and the number of antennas may be the same as the number of signal processors 300 to be described below.

According to the example described herein, the antenna system 100 includes a first antenna A1 and a second antenna A2 configured to transmit and receive a first signal and a second signal. However, the antenna system 100 is not limited to this particular example, and three or more antennas may be provided.

The first signal may be one of a Bluetooth signal and a WLAN signal, and the second signal may be the other of a Bluetooth signal and a WLAN signal.

Further, the antennas A1 and A2 may be multiband antennas capable of transmitting and receiving frequency signals within multiple bands in order to transmit and receive a Bluetooth signal, a WLAN signal, and the like. In addition, the antennas A1 and A2 may be formed as a single antenna structure having a unified structure capable of transmitting and receiving a Bluetooth signal, a WLAN signal, and the like, and may be provided as an antenna such as a microstrip antenna, a patch antenna, or the like, to further miniaturize and simplify the communications device 10.

The communications device 10 further includes a signal processor 300 and a channel information processor 400.

The signal processor 300 is connected to the antenna system 100 through the communications controller 200.

The signal processor 300 converts the signals transmitted and received through the antennas A1 and A2. Specifically, the signal processor 300 converts data transferred from a main board (not illustrated) included in the communications device 10 to generate signals, and converts the signals received through the antennas A1 and A2 into data and transfers the data to the main board.

The signal may be a packet, and a packet size of the generated signal may be determined according to a channel modeling for a frequency band and a wireless system specification for each wireless communications standard. For example, in a case in which the wireless communications standard is 802.11b, a signal up to 1024 bytes at maximum may be generated to be transmitted and received. In a case in which the wireless communications standard is 802.11ac, a signal up to 4096 bytes at maximum may be generated to be transmitted and received.

In addition, the signal processor 300 includes, for example, a Bluetooth signal processor 310 and a WLAN signal processor 320, as illustrated in FIG. 2. The Bluetooth signal processor 310 converts the data transferred from the main board according to the Bluetooth communications standard to generate a Bluetooth signal. In addition, the Bluetooth signal processor 310 converts the Bluetooth signal received through the antenna system 100 into data according to the Bluetooth communications standard.

The WLAN signal processor 320 converts the data transferred from the main board according to the WLAN communications standard to generate a WLAN signal, and converts the WLAN signal received through the antenna system 100 into data according to the WLAN communications standard.

The Bluetooth signal processor 310 and the WLAN signal processor 320 may convert the data into a signal having a maximum packet size according to channel modeling for a frequency band and a wireless system specification for their respective wireless communications standards.

The channel information processor 400 is connected to the antenna system 100 through the communications controller 200. The channel information processor 400 processes channel information on channels obtained through the antennas A1 and A2 and the communications standards, respectively. The channel information may be at least one of quality of service (QoS), noise, interference, loss, fading, and correlation.

The channel information processor 400 processes channel information of each of the antennas A1 and A2 through preamble signals or pilot signals received by the antennas A1 and A2. Specifically, the channel information processor 400 processes channel information such as channel states (loss, fading) of the antennas A1 and A2, distribution degree (interference) of users for each of the antennas A1 and A2, correlation between the antennas A1 and A2, a service that the user wishes to receive through a corresponding channel, quality of service (QoS), and the like, through the preamble signals received by the antennas A1 and A2. The channel information processed by the channel information processor 400 is transferred to the communications controller 200.

The communications controller 200 includes a signal modulator 210 and antenna controller 220, as illustrated in FIG. 3.

The signal modulator 210 modulates the signal on the basis of the channel information. The signal modulator 210 receives the processed channel information from the channel information processor 400. The signal modulator 210 selects a modulation mode on the basis of the channel information received from the channel information processor 400 to modulate the Bluetooth signal and the WLAN signal.

For example, in a case in which it is determined that a channel of each of the antennas A1 and A2 has a good channel gain across a pass band and does not have deep fading, through the channel information of each of the antennas A1 and A2 received from the channel information processor 400, the signal modulator 210 may determine that the channel states of the antennas A1 and A2 are good. In a case in which it is determined that the channel states of the antennas A1 and A2 are good, the signal may be transmitted at a high data rate (HDR) through the antennas A1 and A2. In this case, the signal modulator 210 may select a high order modulation mode to modulate the signal. Thus, the signal modulator 210 may perform a modulation in which the Bluetooth signal and the WLAN signal are converted from 16 quadrature amplitude modulation (QAM) to 256 QAM, and a bandwidth is also increased from 20 MHz to 80 MHz.

In addition, the signal modulator 210 may determine the packet size of the signal on the basis of the channel information and divide the packet size. The signal modulator 210 may divide the Bluetooth signal and the WLAN signal generated to have the maximum packet size allowed by the Bluetooth signal processor 310 and the WLAN signal processor 320, on the basis of the channel information processed by the channel information processor 400.

For example, the signal modulator 210 may divide the Bluetooth signal and the WLAN signal to have a large packet size in a case in which it is determined that the channel states of the antennas A1 and A2 are good, and divide the Bluetooth signal and the WLAN signal to have a small packet size in a case in which it is determined that the channel states of the antennas A1 and A2 are poor.

The antenna controller 220 controls the antennas A1 and A2 to transmit and receive a plurality of signals modulated by the signal modulator 210 which are divided according to the transmission and reception intervals in the antennas A1 and A2. The antenna controller 220 receives the processed channel information from the channel information processor 400 to determine a communications state of each of the first antenna A1 and the second antenna A2.

In addition, the antenna controller 220 may control the transmission and reception of a multiplexed signal while hopping the antennas A1 and A2, depending on the communications states of the first antenna A1 and the second antenna A2. That is, the antenna controller 220 may determine the communications state of each of the first antenna A1 and the second antenna A2 on the basis of the channel information, and may control the antennas A1 and A2 to transmit and receive the plurality of signals modulated by the signal modulator 210 which are divided according to the transmission and reception intervals in each of the antennas A1 and A2 depending on the determined result.

For example, the antenna controller 220 may perform controlling so that the Bluetooth signal and the WLAN signal having large packet sizes are multiplexed and transmitted through the first antenna A1 (or the second antenna A2) of which the communications state is determined to be relatively good on the basis of the channel information, and may perform controlling so that the Bluetooth signal and the WLAN signal having small packet sizes are multiplexed and transmitted through the second antenna A2 (or the first antenna A1) of which the communications state is determined to be relatively poor on the basis of the channel information.

Meanwhile, the antenna controller 220 may control the antennas A1 and A2 to transmit and receive different signals in adjacent transmission and reception intervals. For example, in a case in which the Bluetooth signal is transmitted or received in a first interval of the first antenna A1, the WLAN signal may be transmitted or received in a second interval of the first antenna A1. Thus, each of the first antenna A1 and the second antenna A2 may alternately transmit and receive the Bluetooth signal and the WLAN signal in a plurality of transmission and reception intervals.

Thus, the communications controller 200 according to the embodiment described above may control the antennas A1 and A2 to transmit and receive different signals in the adjacent transmission and reception intervals by the antenna control controller 220 as described above. In addition, the antenna controller 220 may control the antennas A1 and A2 to transmit and receive different signals in transmission and reception intervals corresponding to each other.

For example, in a case in which the Bluetooth signal is initially transmitted or received in the first interval of the first antenna A1, the WLAN signal may be initially transmitted or received in the first interval of the second antenna A2. In addition, in a case in which the WLAN signal is transmitted or received in the second interval of the first antenna A1, the Bluetooth signal may be transmitted or received in the second interval of the second antenna A2.

Thus, the communications controller 200 may control the antennas A1 and A2 to transmit and receive different signals in the transmission and reception intervals corresponding to each other by the antenna controller 220 as described above.

Therefore, the antenna controller 220 may control the antennas A1 and A2 to transmit and receive different signals in the transmission and reception intervals corresponding to each other while transmitting and receiving different signals in the transmission and reception intervals which are adjacent to each other.

As a result, as illustrated by way of example in FIG. 4, in the first interval, the first antenna A1 receives or transmits the Bluetooth signal and the second antenna A2 receives or transmits the WLAN signal at the same time. On the other hand, in the second interval, the first antenna A1 receives or transmits the WLAN signal and the second antenna A2 receives or transmits the Bluetooth signal at the same time. In addition, in a third interval, the first antenna A1 receives or transmits the Bluetooth signal again and the second antenna A2 receives or transmits the WLAN signal at the same time.

That is, the communications controller 200 as described above may transmit and receive the Bluetooth signal and the WLAN signal by dividing the Bluetooth signal and the WLAN signal for each transmission and reception interval so as not to generate a null interval in which the Bluetooth signal and the WLAN signal are not transmitted or received in the transmission and reception intervals of the antennas A1 and A2 at the time of transmitting and receiving the Bluetooth signal and the WLAN signal through the antennas A1 and A2.

For example, it is assumed that the Bluetooth signal is transmitted or received in the first interval and the third interval through the first antenna A1, and the second interval is a null transmission and reception interval in which the Bluetooth signal is not transmitted or received. In this case, the signal modulator 210 may divide the WLAN signal to correspond to a packet size of the null transmission and reception interval. In addition, the antenna controller 220 may control the divided WLAN signal to be transmitted or received in the second interval of the first antenna A1, thereby preventing an occurrence of the null transmission and reception interval in the antennas A1 and A2.

As a result, the communications controller 200 may perform controlling so that a plurality of transmission and reception intervals are set for each of the antennas A1 and A2 and the plurality of signals are divided for each transmission and reception interval in each of the antennas A1 and A2, according to the configuration as described above.

Therefore, the communications device 10 transmits and receives the plurality of signals by dividing the plurality of signals according to the transmission and reception intervals in each of the antennas A1 and A2, thereby more efficiently transmitting and receiving the plurality of signals. As a result, processing speed of the network system may be improved, and power consumption thereof may be reduced.

In addition, each of the plurality of antennas A1 and A2 transmits and receives the plurality of signals, such that communications may be smoothly performed without interference and clashes between the plurality of systems throughout the network system may be improved, and a diversity gain may also be improved.

Meanwhile, the antenna controller 220 may control a copy of signals to be transmitted and allow the copied signals to be repeatedly transmitted. As a result, the antenna controller 220 may perform controlling so that the copied signals are repeatedly transmitted through the antennas A1 and A2 while having a predetermined time difference, for example, a time difference of 400 ns, whereby beamforming accidentally generated at the time of transmitting the same signal from the antennas A1 and A2 may be prevented, and consequently, signals received from different channels may be selectively restored. Therefore, a likelihood of reception of the signal may be further increased.

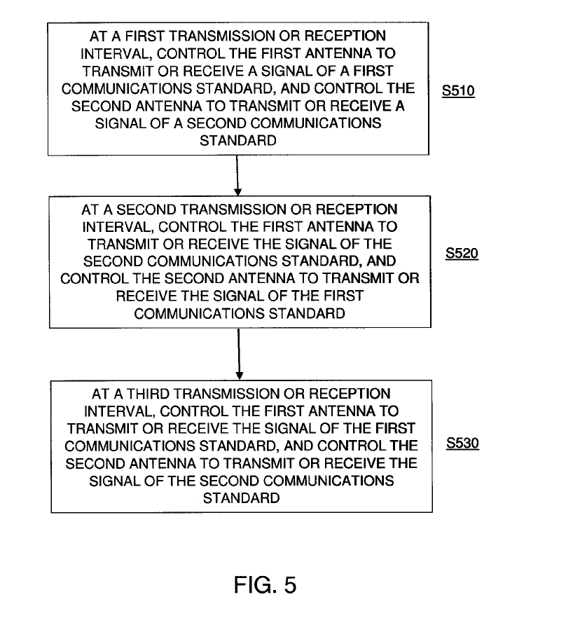

An example method of operating the communications device 10 will be described with reference to FIG. 5.

Referring to FIG. 5, in operation S510, at a first transmission or reception interval, the communications controller 200 controls the first antenna A1 to transmit or receive a signal of a first communications standard (e.g., one of Bluetooth and WLAN), and controls the second antenna A2 to transmit or receive a signal of a second communications standard (e.g., the other of Bluetooth and WLAN). Thereafter, in operation S520, at a second transmission or reception interval, the communications controller 200 controls the first antenna A1 to transmit or receive the signal of the second communications standard, and controls the second antenna to transmit or receive the signal of the first communications standard. Subsequently, in operation S530, the communications controller 200 controls the first antenna A1 to transmit or receive the signal of the first communications standard, and controls the second antenna A2 to transmit or receive the signal of the second communications standard.

As set forth above, according to the examples in disclosed herein, the communications device 10 using the multiple antennas A1 and A2 efficiently transmits and receives the plurality of signals, whereby the processing speed of the network system may be improved and the power consumption thereof may be reduced. In addition, in building the plurality of network systems in the single communications device, the communications may be smoothly performed without interference and clashes between the plurality of network systems at the time of transmitting and receiving the plurality of signals through the plurality of antennas.

The apparatuses, units, modules, devices, and other components illustrated in FIGS. 1-3 (e.g., the communications controller 200, the signal modulator 210, the antenna controller 220, the signal processor 300, the WLAN signal processor 310, the Bluetooth signal processor 320 and the channel information processor 400) that perform the operations described herein with respect to FIG. 5 are implemented by hardware components. Examples of hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIG. 5. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIG. 5 that perform the operations described herein with respect to FIGS. 1-3 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A communications device, comprising:
antennas; and
a communications controller configured to control each of the antennas to have a plurality of transmission or reception intervals, and to transmit and receive a plurality of signals according to the transmission or reception intervals.

2. The communications device of claim 1, wherein the communications controller is configured to control the antennas to transmit and receive different signals in adjacent transmission or reception intervals.

3. The communications device of claim 2, wherein the communications controller is configured to control the antennas to transmit or receive different signals in transmission or reception intervals corresponding to each other.

4. The communications device of claim 1, wherein:
the antennas include a first antenna and a second antenna;
the plurality of signals includes a first signal and a second signal; and
each of the first antenna and the second antenna alternately transmits or receives the first signal and the second signal in the plurality of transmission or reception intervals.

5. The communications device of claim 4, wherein the first antenna initially transmits or receives the first signal, and the second antenna initially transmits or receives the second signal.

6. The communications device of claim 1, further comprising a signal processor configured to convert the plurality of signals.

7. The communications device of claim 6, wherein the signal processor comprises a plurality of signal processors corresponding in number to the antennas.

8. The communications device of claim 6, wherein the signal processor comprises:
a Bluetooth signal processor configured to convert a signal, among the plurality of signals, according to a Bluetooth communications standard; and
a wireless LAN (WLAN) signal processor configured to convert another signal, among the plurality of signals, according to a WLAN communications standard.

9. The communications device of claim 1, further comprising a channel information processor configured to process channel information of the antennas.

10. The communications device of claim 9, wherein the channel information processor is configured to process the channel information from preamble signals or pilot signals received by the antennas.

11. The communications device of claim 9, wherein the channel information comprises at least one of quality of service (QoS), noise, interference, loss, fading, or correlation.

12. The communications device of claim 9, wherein the communications controller includes:
a signal modulator configured to modulate the plurality of signals on the basis of the channel information; and
an antenna controller configured to control the antennas to transmit and receive the plurality of signals modulated by the signal modulator which are divided according to the transmission or reception intervals.

13. The communications device of claim 12, wherein the antenna controller is configured to control the antennas to transmit or receive different signals in adjacent transmission or reception intervals.

14. The communications device of claim 13, wherein the antenna controller is configured to control the antennas to transmit or receive different signals in transmission or reception intervals corresponding to each other.

15. The communications device of claim 1, wherein the communications controller is configured to control a copy of the plurality of signals and is configured to allow the copied signals to be repeatedly transmitted.

16. A method of operating a communications device, comprising:
controlling, by a communications controller, at a first transmission or reception interval, a first antenna to transmit or receive a signal of a first communications standard;
controlling, by the communications controller, at the first transmission or reception interval, the second antenna to transmit or receive a signal of a second communications standard;
controlling, by the communications controller, at a second transmission or reception interval, the first antenna to transmit or receive the signal of the second communications standard; and
controlling, by the communications controller, at the second transmission or reception interval, the second antenna to transmit or receive the signal of the first communications standard.

17. The method of claim 16, further comprising:
controlling, by the communications controller, at a third transmission or reception interval, the first antenna to transmit or receive the signal of the first communications standard; and
controlling, by the communications controller, at the third transmission or reception interval, the second antenna to transmit or receive the signal of the second communications standard.

18. The method of claim 16, wherein the first communications standard is one of Bluetooth and WLAN and the second communications standard is the other of Bluetooth and WLAN.
